(19) United States
(12) Patent Application Publication
(10) Pub. No.: US 2014/0077958 A1
(43) Pub. Date: Mar. 20, 2014

(54) WATER LEVEL DETECTION DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: YONG-CHANG FAN, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/891,037

(22) Filed: May 9, 2013

(30) Foreign Application Priority Data
Sep. 14, 2012 (CN) 2012103397733

(51) Int. Cl. G01F 23/64

(52) U.S. Cl. CPC G01F 23/64
USPC 340/623

(57) ABSTRACT

A water level detection device includes a case, a detection assembly, and a latching ring secured to the case. The detection assembly includes a warning module, a micro switch, a cable, and a floater. The cable is inserted through the latching ring and divided to a first section connected to the micro switch and a second section connected to the floater. When a water level is in an upper limit or a lower limit, the second section is tight, and an angle is defined between the second section and the first section. When the water level is between the upper and the lower limit, the second section is loose. When the water level is over the upper limit or under the lower limit, the floater pulls the first section via the second section to trigger the micro switch to alarm the warning module.

### BACKGROUND

1. Technical Field

The present disclosure relates to detection devices, and particularly to a water level detection device.

2. Description of Related Art

Generally, a water level detection device includes two parallel wires secured to a position in a preset water level and a warning device. Because the impedances of the two wires are different when in the water and in the air, when a water level is over or below the preset water level, the impedances of the two wires will be changed, so that the warning device sounds. However, when the two wires are immersed in water for a long time, especially corrosive water, the two parallel wires may become corroded, and the impedances of the two parallel wires will be changed to causing the warning device to sound in error. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a water level detection device.

FIG. 2 is an assembled, isometric view of the water level detection device of FIG. 1.

FIG. 3 is another assembled, isometric view of the water level detection device of FIG. 1 showing a part of a case, and a floater is located in an upper limit level.

FIG. 4 is similar to FIG. 3, but the floater is located in a lover limit level.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

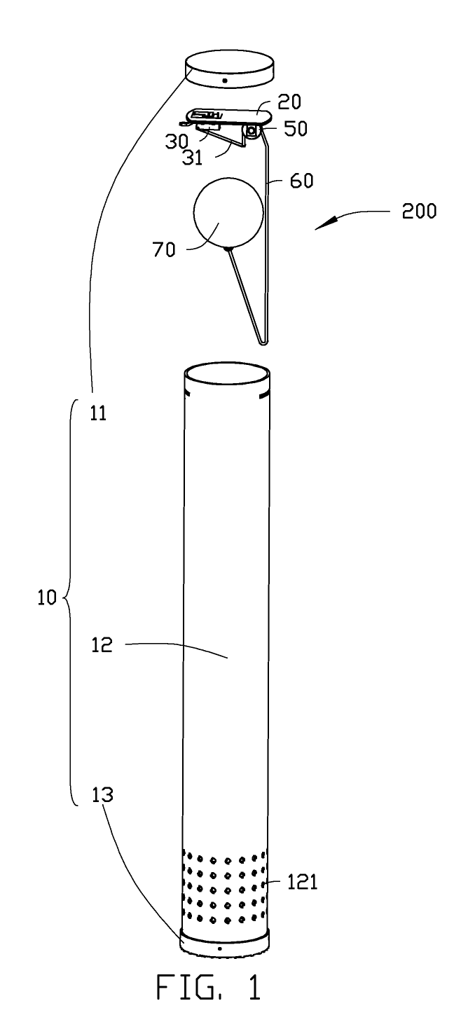

FIG. 1 shows a water level detection device in accordance with an embodiment. The water level detection device includes a case 10 and a detection assembly 200.

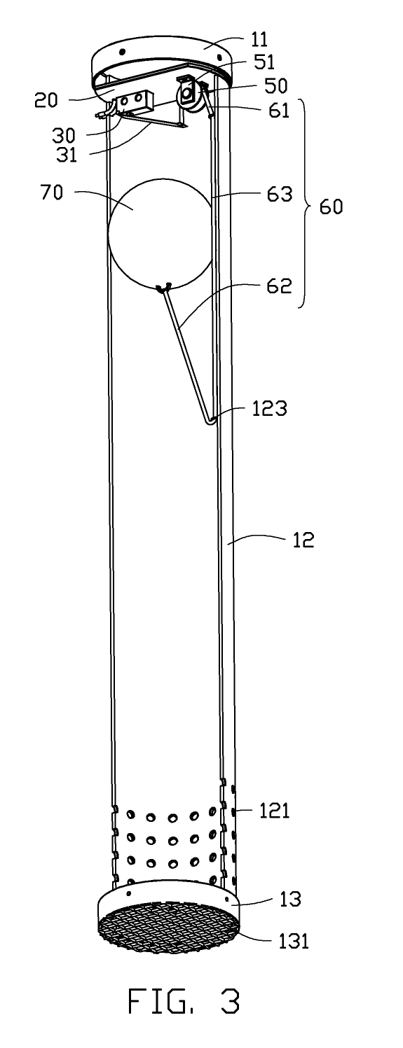

The case 10 includes a top cover 11, a case body 12, and a bottom cover 13. The top cover 11 can be secured to a top end of the case body 12 to prevent dust and water pass into the case 10. The case body 12 is used for receiving the detection assembly 200. A bottom end of the case body 12 defines a plurality of holes 121 for liquid flowing through. A plurality of latching rings 123 (shown as in FIG. 3) is secured to an inner surface of the case body 12. The bottom cover 13 can be secured to the bottom end of the case body 12. The bottom cover 13 includes a strainer mesh 131 (shown as in FIG. 3) for catching impurities in the liquid. In one embodiment, the case body 12 is a cylinder.

The detection assembly 200 includes a warning module 20, a micro switch 30, a pulley 50, a cable 60, and a floater 70.

The warning module 20 can be secured to the inner surface of the case body 12 and used for outputting a warning signal.

The micro switch 30 includes a resilient piece 31. The resilient piece 31 is elastically deformable to trigger the micro switch 30. The warning module 20 alarms when the micro switch 30 is triggered.

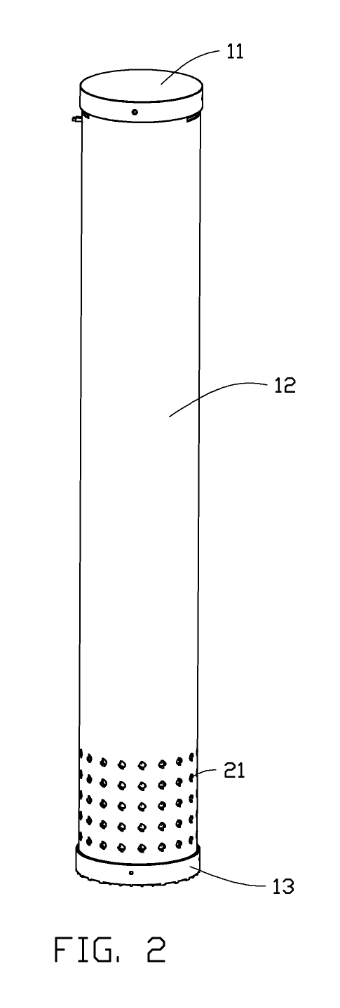

FIGS. 1-3 show that in assembly of the detection assembly 200, the micro switch 30 is secured and is electronically connected to the warning module 20. The pulley 50 is secured to the warning module 20 by two securing pieces 51. A first end of the cable 60 is drove through the pulley 50 and secured to the resilient piece 31. A second end of the cable 60 is used for connecting the floater 70.

FIGS. 1-3 show that in assembly of the water level detection device, the detection assembly 200 is placed into the case body 12, and the warning module 20 is secured to the inner surface of the case body 12 with screws (not shown). The second end of the cable 60 is drove through two latching rings 123, and then the cable 60 is divided into a first section 61, a second section 62, and a third section 63. The first section 61 is drove through the pulley 50 and secured to the resilient piece 31. The third section 63 is between the two latching rings 123. The second section 62 connects the floater 70. The third section 63 is connected between the first section 61 and the second section 62. An angle is defined between the second section 62 and the third section 63. The bottom cover 13 is secured to the bottom end of the case body 12, and the top cover 11 is secured to the top end of the case body 12 with screws or other securing members. A deforming direction of the resilient piece 31 is opposite to a moving direction of the second section 62.

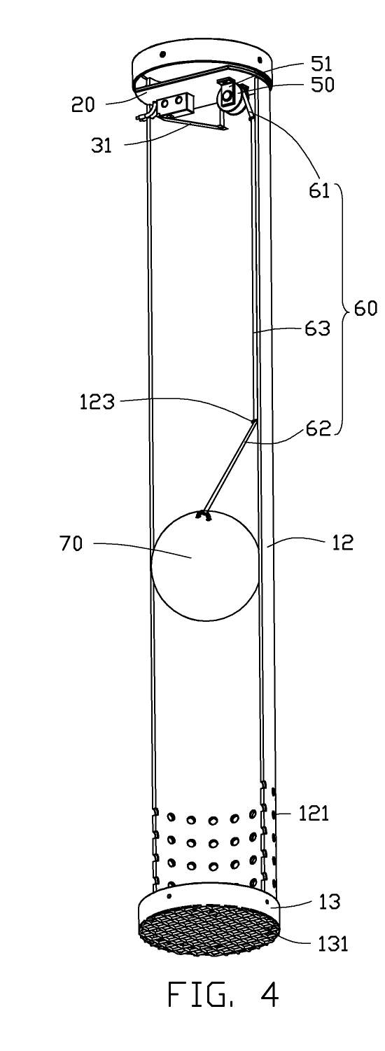

In use, the water lever detection device is placed in a liquid cell, and the liquid flows into the case body 12 through the holes 121 and the strainer mesh 131. As shown in FIG. 3, when a water lever of the liquid cell is an upper limit, the floater 70 is in a first position. In this first position, the second section 62 is tight, and an acute angle is defined between the third section 63 and the second section 62 (as shown in FIG. 3), are as appears in FIG. 4, when a water lever of the liquid cell is a lower limit, the floater 70 is in a second position. In this second position, the second section 62 is tight, and an obtuse angle is defined between the third section 63 and the second section 62. When the water lever is between the upper limit and the lower limit, the gravity of the floater 70 is equal to buoyancy of the floater 70, and the floater 70 is located between the first position and the second position. The cable 60 is loose releasing the floater 70.

When the water level is over the upper limit, a volume immersion in the liquid of the floater 70 is greater than a volume immersion in the liquid of the floater 70 when the floater 70 is in the first position. In this position, the buoyancy for the floater 70 is greater than the gravity of the floater 70, so the floater 70 pulls the second section 62 of the cable 60 to move upwards. Thus, the first section 61 and third section 63 are pulled by the second section 62 and elastically deform the resilient piece 31, and then the warning module 20 sounds to output a warning signal that the water level is abnormal.

When the water level is under the lower limit, a volume of immersion in the liquid of the floater 70 is smaller than a volume of immersion in the liquid of the floater 70 when the floater 70 is in the second position. In this position, the gravity of the floater 70 is greater than the buoyancy for the floater 70, so the floater 70 pulls the second section 62 of the cable 60 downwards. Thus, the first section 61 and third section 63 are pulled by the second section 62 and elastically deform the resilient piece 31, and then the warning module 20 alarms to output a signal that the water level is abnormal.

A distance between the two latching rings 123 can be changed to change a length of the second section 62, and then the upper limit and the lower limit of the water level are changed. The warning module 20 and the micro switch 30 are always located over the upper limit.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A water level detection device, for detecting a water level of a liquid cell, comprising:
a case;
two latching rings secured to an inner surface of the case; and
a detection assembly received in the case comprising a warning module, a micro switch, a cable, and a floater
wherein the cable is inserted through the two latching rings and comprises a first section connected to the micro switch and a second section connected to the floater; the warning module and the micro switch are located above the floater; the floater is adapted to float on the liquid cell; when the water level of the liquid cell is located in an upper limit or a lower limit, the second section is tight, and an angle is defined between the second section and the second section; when the water level of the liquid cell is between the upper limit and the lower limit, the second section is loose; and when the water level is over the upper limit or under the lower limit, the floater pulls the first section via the second section to trigger the micro switch to alarm the warning module.

2. The water level detection device of claim 1, wherein the water level of the liquid cell is in the upper limit, an acute angle is defined between the first section and the second section; and when the water level of the liquid cell is in the lower limit, an obtuse angle is defined between the first section and the second section.

3. The water level detection device of claim 1, wherein the case comprises a case body, a top cover, and a bottom cover; the warning module is secured to the inner surface of the case body; the two latching rings is secured to the inner surface of the case body; and the top cover and the bottom cover are secured to opposite ends of the case body.

4. The water level detection device of claim 3, wherein the top cove covers the case body to prevent dust and water pass into the case body; and the warning module is adjacent to the top cover.

5. The water level detection device of claim 3, wherein the bottom cover defines a plurality of holes for liquid flowing through, and the plurality of holes are adjacent to the bottom cover.

6. The water level detection device of claim 5, wherein the bottom cover comprises a strainer mesh for catching impurities in the liquid.

7. The water level detection device of claim 1, further comprises a pulley, wherein the first section is rove through the pulley and connected to the micro switch.

8. The water level detection device of claim 7, wherein the pulley is secured to the warning module.

9. The water level detection device of claim 1, wherein the micro switch comprises a resilient piece, and the first section is secured to the resilient piece; and the resilient piece is elastically deformable to trigger the micro switch.

10. The water level detection device of claim 1, wherein the cable further comprises a third section connected between the first section and the second section, and the third section is between the two latching rings; and a distance between the two latching rings is capable of being changed to change a length of the second section, so as to change the upper limit and the lower limit of the water level.

11. A water level detection device, for detecting a water level of a liquid cell, comprising:
a case;
two latching rings secured to an inner surface of the case; and
a detection assembly received in the case comprising a warning module, a micro switch, a cable, and a floater
wherein the cable is inserted through the two latching rings and comprises a first section, a second section, and a third section connected to the first section and the second section; the first section is connected to the micro switch, the second section is connected to the floater, and the third section is between the two latching rings; the warning module and the micro switch are located above the floater; the floater is adapted to float on the liquid cell; when the water level of the liquid cell is located in an upper limit or a lower limit, the second section is tight, and an angle is defined between the second section and the second section; when the water level of the liquid cell is between the upper limit and the lower limit, the second section is loose; and when the water level is over the upper limit or under the lower limit, the floater pulls the first section via the second section to trigger the micro switch to alarm the warning module; and a distance between the two latching rings is capable of being changed to change a length of the second section, so as to change the upper limit and the lower limit of the water level.

12. The water level detection device of claim 11, wherein the water level of the liquid cell is in the upper limit, an acute angle is defined between the third section and the second section; and when the water level of the liquid cell is in the lower limit, an obtuse angle is defined between the third section and the second section.

13. The water level detection device of claim 11, wherein the case comprises a case body, a top cover, and a bottom cover; the warning module is secured to the inner surface of the case body; the two latching rings is secured to the inner surface of the case body; and the top cover and the bottom cover are secured to opposite ends of the case body.

14. The water level detection device of claim 13, wherein the top cove covers the case body to prevent dust and water pass into the case body; and the warning module is adjacent to the top cover.

15. The water level detection device of claim 13, wherein the bottom cover defines a plurality of holes for liquid flowing through, and the plurality of holes are adjacent to the bottom cover.

16. The water level detection device of claim 15, wherein the bottom cover comprises a strainer mesh for catching impurities in the liquid.

17. The water level detection device of claim 11, further comprises a pulley, wherein the first section is rove through the pulley and connected to the micro switch.

18. The water level detection device of claim 17, wherein the pulley is secured to the warning module.

19. The water level detection device of claim 11, wherein the micro switch comprises a resilient piece, and the first section is secured to the resilient piece; and the resilient piece is elastically deformable to trigger the micro switch.
